(19) United States
(12) Patent Application Publication
(10) Pub. No.: US 2016/0182114 A1
(43) Pub. Date: Jun. 23, 2016

(54) PROTECTIVE COVER AND SHELL THEREOF

(71) Applicant: HON HAI PRECISION INDUSTRY CO., LTD., New Taipei (TW)

(72) Inventor: LI-WEN TIEN, New Taipei (TW)

(21) Appl. No.: 14/642,252

(22) Filed: Mar. 9, 2015

(30) Foreign Application Priority Data
Dec. 19, 2014 (CN) 201410792314.X

(51) Int. Cl. H04B 1/3888; A45F 5/00

(52) U.S. Cl. CPC H04B 1/3888; A45F 5/00

(57) ABSTRACT

A protective cover includes a first shell and a second shell for receiving the first shell. The first shell includes a first bottom plate and an integral first side wall extending from the edge of the first bottom plate. The first bottom plate and the first side wall cooperate to form a first concave portion for receiving a portable device. An external surface of the first side wall forms a number of convex portions, and an internal surface of the first side wall defines a number of recesses corresponding to the convex portions. When the portable device is received in the first concave portion, thereby forming a number of air cavities in the recesses between the first shell and the portable device to entrap air, so as to provide cushions to protect the portable device against shock.

### CROSS-REFERENCE TO RELATED APPLICATIONS

This application claims priority to Chinese Patent Application No. 201410792314.X filed on Dec. 19, 2014, the contents of which are incorporated by reference herein.

### FIELD

The subject matter herein generally relates to protective covers for receiving and protecting portable devices.

### BACKGROUND

A protective cover is usually used for receiving and protecting a portable device.

### BRIEF DESCRIPTION OF THE DRAWINGS

Implementations of the present disclosure will now be described, by way of example only, with reference to the attached figures.

FIG. 1 is an isometric view of a protective cover.

FIG. 2 is an exploded, isometric view of the protective cover of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts can be exaggerated to better illustrate details and features of the present disclosure.

A definition that applies throughout this disclosure will now be presented.

The term “comprising” means “including, but not necessarily limited to”; it specifically indicates open-ended inclusion or membership in a so-described combination, group, series and the like.

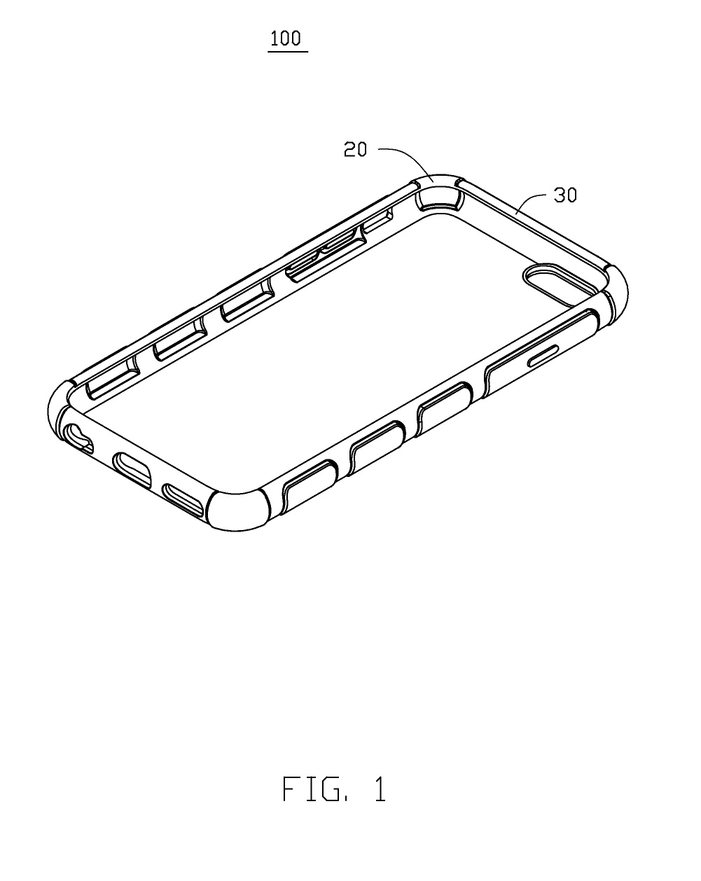

FIG. 1 is an isometric view of a protective cover 100 for receiving and protecting a portable device (not shown). In one embodiment, the portable device can be an electronic device, such as a smart phone, or a tablet computer.

In one embodiment, the protective cover 100 includes, but is not limited to, a first shell 20 and a second shell 30 for receiving the first shell 20.

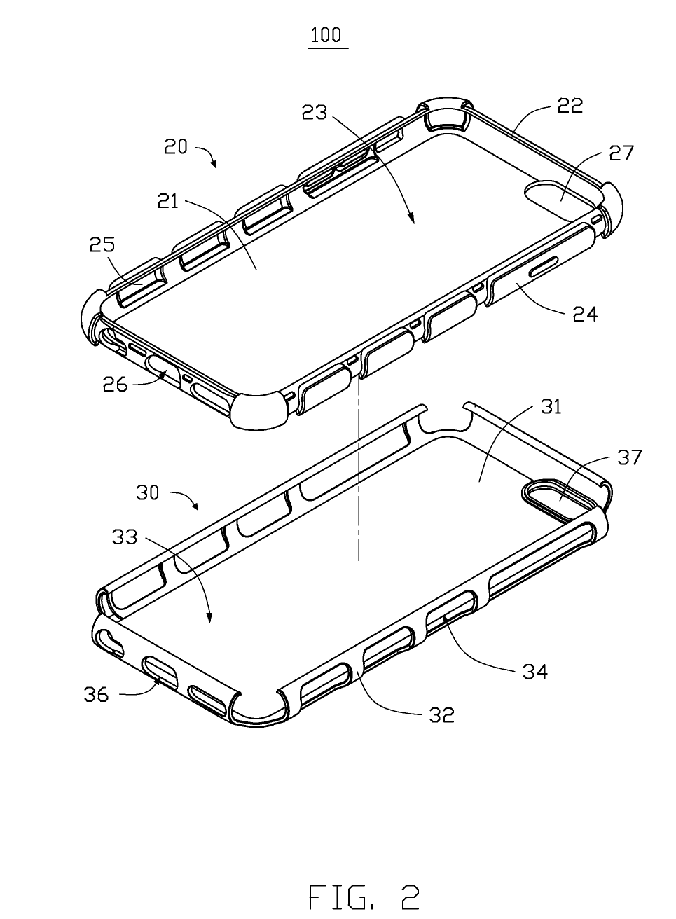

FIG. 2 illustrates that, in at least one embodiment, the first shell 20 includes, but is not limited to, a first bottom plate 21 and an integral first side wall 22 extending from an edge of the first bottom plate 21. In at least one embodiment, the first side wall 22 can substantially vertically extend from the edge of the first bottom plate 21. The first bottom plate 21 and the first side wall 22 cooperate to form a first concave portion 23 for receiving the portable device.

In at least one embodiment, an external surface of the first side wall 22 forms a number of convex portions 24, and an internal surface of the first side wall 22 defines a number of recesses 25 corresponding to the convex portions 24. When the portable device is received in the first concave portion 23, a number of air cavities are thereby formed in the recesses 25 between the first shell 20 and the portable device to entrap air, so as to provide cushions to protect the portable device against shock when the portable device is dropped.

In at least one embodiment, the first shell 20 is made of one or more flexible materials, such as Thermoplastic polyurethanes (TPU), Thermoplastic Elastomer (TPE), Polyurethane (PU), or Silicone, therefore, the first shell 20 is formed to be a soft shockproof cover.

In at least one embodiment, the second shell 30 includes, but is not limited to, a second bottom plate 31 and an integral second side wall 32 extending from the edge of the second bottom plate 31. In at least one embodiment, the second side wall 32 can substantially vertically extend from the edge of the second bottom plate 31. The second bottom plate 31 and the second side wall 32 cooperate to form a second concave portion 33, which matches with the first shell 20 and is configured to receive the first shell 20.

In at least one embodiment, a number of receiving holes 34 are defined on the second side wall 32 for receiving the convex portions 24 formed on the first shell 20, thereby the first shell 20 is firmly received in the second shell 30.

In at least one embodiment, the second shell 30 is made of one or more rigid materials, such as Polycarbonate (PC), Acrylonitrile Butadiene Styrene (ABS), and hard rubber, therefore, the second shell 30 is formed to be a rigid shockproof cover to prevent excessive deformation of the soft first shell 20, and prevent damage of the portable device due to vibration displacement.

In at least one embodiment, at least one pair of through holes 26 and 36 spatially correspond to each other and are respectively defined on the first side wall 22 and the second side wall 32. The through holes 26 and 36 are configured to expose outside functional components, such as a charge jack, a headphone jack, a power button, or volume buttons, of the portable device which is received in the protective cover 100.

In at least one embodiment, a pair of camera holes 27 and 37 spatially correspond to each other and are respectively defined on the first bottom plate 21 and the second bottom plate 31. The camera holes 27 and 37 are configured to be exposed outside a camera of the portable device which is received in the protective cover 100.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in particular the matters of shape, size, and arrangement of parts within the principles of the present disclosure, up to and including the full extent established by the broad general meaning of the terms used in the claims.

What is claimed is:

1. A shell for forming a protective cover, the shell comprising:
a bottom plate; and
an integral side wall extending from an edge of the bottom plate, wherein the bottom plate and the side wall cooperate to form a concave portion for receiving a portable device; wherein an internal surface of the side wall defines a plurality of recesses, when the portable device is received in the concave portion, thereby forming a plurality of air cavities in the recesses between the shell and the portable device to entrap air, so as to provide cushions to protect the portable device against shock.

2. The shell of claim 1, wherein an external surface of the side wall forms a plurality of convex portions corresponding to the recesses.

3. The shell of claim 1, wherein the side wall vertically extends from the edge of the bottom plate.

4. The shell of claim 1, wherein the shell is made of one or more flexible materials.

5. The shell of claim 4, wherein the flexible materials are selected from a group consisting of Thermoplastic polyurethanes, Thermoplastic Elastomer, Polyurethane, and Silicone.

6. A protective cover comprising:
a first shell comprising:
a first bottom plate; and
an integral first side wall extending from an edge of the first bottom plate, wherein the first bottom plate and the first side wall cooperate to form a first concave portion for receiving a portable device; wherein an internal surface of the first side wall defines a plurality of recesses, when the portable device is received in the first concave portion, thereby forming a plurality of air cavities in the recesses between the first shell and the portable device to entrap air, so as to provide cushions to protect the portable device against shock; and
a second shell for receiving the first shell, the second shell comprising:
a second bottom plate; and
an integral second side wall extending from the edge of the second bottom plate, wherein the second bottom plate and the second side wall cooperate to form a second concave portion, which matches with the first shell and is configured to receive the first shell.

7. The protective cover of claim 6, wherein an external surface of the first side wall forms a plurality of convex portions corresponding to the recesses, and the second side wall defines a plurality of receiving holes for receiving the convex portions formed on the first shell, thereby firmly receiving the first shell in the second shell.

8. The protective cover of claim 6, wherein the first side wall vertically extends from the edge of the first bottom plate.

9. The protective cover of claim 6, wherein the first shell is made of one or more flexible materials.

10. The protective cover of claim 9, wherein the flexible materials are selected from a group consisting of Thermoplastic polyurethanes, Thermoplastic Elastomer, Polyurethane, and Silicone.

11. The protective cover of claim 6, wherein the second side wall vertically extends from the edge of the second bottom plate.

12. The protective cover of claim 6, wherein the second shell is made of one or more rigid materials.

13. The protective cover of claim 12, wherein the rigid materials are selected from a group consisting of Polycarbonate, Acrylonitrile Butadiene Styrene, and hard rubber.

14. The protective cover of claim 6, wherein at least one pair of through holes spatially correspond to each other and are respectively defined on the first side wall and the second side wall, wherein the through holes are configured to expose outside functional components of the portable device which is received in the protective cover.

15. The protective cover of claim 6, wherein a pair of camera holes spatially correspond to each other and are respectively defined on the first bottom plate and the second bottom plate, wherein the camera holes are configured to be exposed outside a camera of the portable device which is received in the protective cover.
